(19) United States
(12) Patent Application Publication
(10) Pub. No.: US 2018/0300663 A1
(43) Pub. Date: Oct. 18, 2018

(54) DETERMINING A PEER BUSINESS RELATIONSHIP VALUE FOR SETTLEMENT FREE PEERS

(71) Applicant: Guavus, Inc., SAN MATEO, CA (US)

(72) Inventors: Mohinder Paul, Gurgaon (IN); Aditya Kumar, Haryana (IN); Pragati Kumar Dhingra, New Delhi (IN)

(21) Appl. No.: 15/489,720

(22) Filed: Apr. 17, 2017

(51) Int. Cl. G06Q 10/06; H04L 12/26

(52) U.S. Cl. CPC G06Q 10/06375; H04L 43/0876

(57) ABSTRACT

A system and method for determining a peer business relationship value is described. The system and method enables at least one peer to communicate with a communications service provider (CSP). The CSP includes a CSP sub-system that determines a data traffic flow for each peer. The CSP sub-system also receives peer information including a total network cost for each peer. The total network cost includes a network asset cost. Additionally, the CSP sub-system determines an attributed revenue for each peer. The CSP sub-system then proceeds to calculate a net margin by subtracting the total network cost from the attributed revenue. The CSP sub-system then calculates the margin per unit traffic by taking the net margin and dividing by the data traffic flow. The CSP sub-system then calculates the net margin percentage by taking the net margin and dividing it by the attributed revenue.

### FIELD OF THE INVENTION

The presently disclosed subject matter relates to methods and systems for determining a peer business relationship value. More specifically, a system and method for finding margins for settlement free peers is described. The peer business relationship value is determined by considering total network cost for each peer and attributing revenue to each peer.

### BACKGROUND

Administratively separate network providers voluntarily interconnect for the purpose of exchanging traffic between users of each network. Globally, network providers rely on settlement-free peering, in which either party does not pay for the traffic exchanged between them. In the settlement-free peering regime, networks derive and retain revenue from customers that pay for access. However, networks do not derive revenue from peer such as other ISPs.

Network providers determine the fairness of peer relationships to value the business efficacy of maintaining a given peer relationship. However, network providers struggle to ensure fair peer relationships and determine a business value of the relationship compared to other peer relationships because ISPs do not measure actual revenues or costs associated with the peer relationship.

Peering managers typically rely on Traffic Input Output Ratio (I/O ratio) or the newer concept of bit-miles received from a traffic reporting tool to determine the “fairness” of the relationship. Presently, there is little or no consensus in the industry regarding how to determine “fairness,” and both aforementioned methods have significant shortcomings, such as requiring information sharing with competing peers to determine bitmiles traversed on each network, and lack of correlation with direct business value in monetary terms. Another complication is that peering traffic I/O ratios are irrelevant to determination of the fairness of a peer relationship, because eventually the traffic traverses the provider's network to get to customers. Any asymmetry in the traffic ratio is merely a side effect of the type of traffic requested by, or on behalf of, customers.

In contrast, network cost proxies, such as bit-miles, represent an attempt to utilize a meaningful metric to determine peer relationship fairness. Fairness determinations based solely on network cost proxies fail to accurately value peer relationships by neglecting to consider revenue derived from the peer relationship. Further, they do not take into account cost of network assets used for such traffic. Bitmiles based fairness evaluation also requires similar information being provided by competitors; which is practically not feasible in real world.

### SUMMARY

A system and method for determining a peer business relationship value is described. The communications service provider (CSP) includes a CSP sub-system that receives a plurality of peer information including CSP's total network cost for carrying traffic exchanged with each peer. In the illustrative embodiment, the total network cost includes a network asset cost. Additionally, the CSP sub-system determines an attributed revenue for each peer. The attributed revenue is attributed to one or more peers and a total of the attributed revenue equals the customer revenue earned from traffic exchanged with peers. The CSP sub-system then proceeds to calculate a net margin by subtracting the total network cost from the attributed revenue. Net margin provides the business value in monetary terms for each peering relationship. The CSP sub-system then determines a data traffic flow for each peer. The CSP sub-system then calculates the peer's business value per unit of traffic exchanged with the peer by taking the net margin and dividing by the rate of data traffic flow exchanged with the peer. The CSP subsystem then proceeds to compute the net margin percentage of each peer. Net margin percentage is computed by dividing a peer's net margin by revenue attributed to that peer and multiplying the result by 100. Net margin, margin per unit of traffic, and net margin percentage together provide the most comprehensive view of a peer's business relationship value for the CSP.

Also, the illustrative system and method updates the peer relationship's business value at a regular interval due to changes in the data traffic flow, the attributed revenue, the total network cost or any combination thereof. In another illustrative embodiment, the attributed revenue is determined monthly. Furthermore, each peer may be ranked at the regular intervals according to their peer relationship value to identify the highest value peer.

In yet another illustrative embodiment attributed revenue is calculated based on a 95^{th} percentile traffic level. Attributed revenue may also be calculated based on a direction of the data traffic flow. Further yet, the total network cost is calculated based on a cost metric.

### DRAWINGS

The presently disclosed subject matter will be more fully understood by reference to the following drawings, which are provided for illustrative purposes only, and not for limiting purposes.

FIG. 1A shows an illustrative communications service provider (CSP) communicatively coupled to a plurality of network peers.

FIG. 1B shows an illustrative Table I that includes Input Output (I/O) ratios and Total Cost per mile.

FIG. 2 shows two customers communicatively coupled to the CSP, which is in communication with the network peers presented in FIG. 1A.

FIG. 3 shows an illustrative flowchart for determining attributed revenue, which is used for ranking peers and determining the peer business value relationship.

FIG. 4 shows an illustrative table that identifies the peer with the highest peer fairness ratio.

FIG. 5 shows an illustrative sub-system associated with the communications service provider (CSP) 100.

### DESCRIPTION

Persons of ordinary skill in the art will realize that the following description is illustrative and not in any way limiting. Other embodiments of the claimed subject matter will readily suggest themselves to such skilled persons having the benefit of this disclosure. It shall be appreciated by those of ordinary skill in the art that the systems and methods described herein may vary as to configuration and as to details. Additionally, the methods may vary as to details, order of the actions, or other variations without departing from the illustrative methods disclosed herein.

The systems and methods presented solve the problems identified above by focusing on the business value of a peer as opposed to “fairness,” which is only a proxy for business value. The systems and methods presented herein focus on computing business value with relevant financial or monetary terms. Additionally, the illustrative systems and methods focus on using CSP data to determine business value; thus, information exchange with competitors is not required. Furthermore, the illustrative systems and methods take into account actual network cost.

Currently available systems and methods are unsatisfactory to evaluate the business value of peers. The systems and methods presented herein rely on “peer margins” or “profitability” being determined by the combination of network costs due to traffic carried and attributed revenues generated from the traffic. Once costs and revenues are known for each peer, then the process of computing margins, e.g. profits, and business value for each peering relationship may be determined. Total network costs for each peer can be determined using a variety of different methods such as bit-miles and asset costs. Attributed revenue is based on customer revenues that are earned on customer ports due to traffic sent to or received from peer ports.

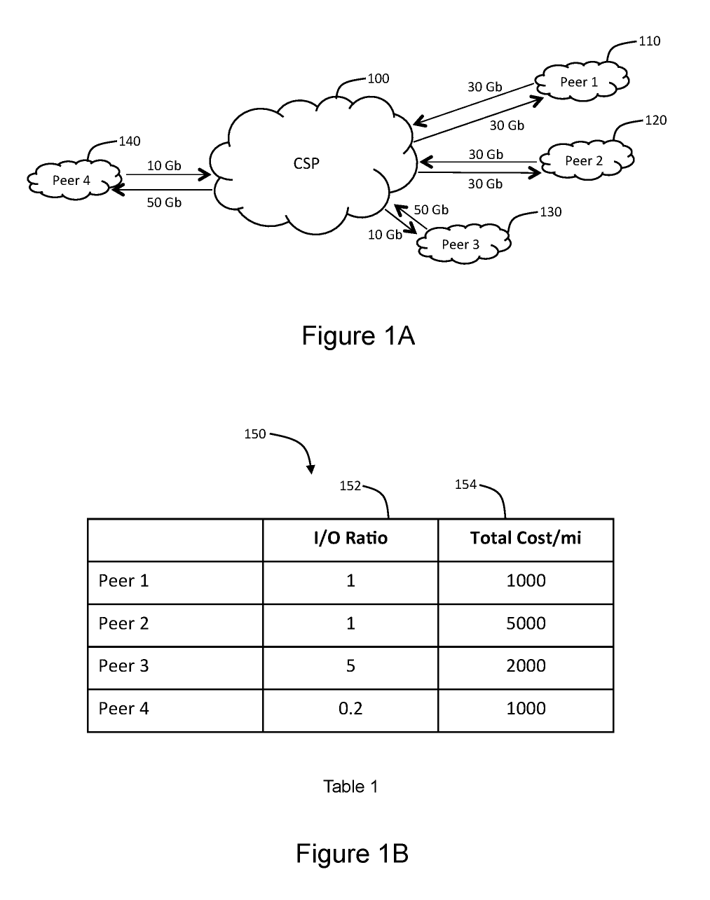

Referring now to FIG. 1A, there is shown an illustrative communications service provider (CSP) 100 communicatively coupled to a plurality of network peers. A communications service provides (CSP) is a service provider that transports information electronically. Some illustrative CSPs include public and private companies in the wired telecom, wireless telecom, Internet, cable, satellite and managed services businesses.

Peering is a voluntary interconnection of administratively separate Internet network for the purpose of exchanging traffic between the users of each network. An agreement by two or more networks to “peer” is instantiated by a physical interconnection of the network, an exchange of routing information through the Border Gateway Protocol (BGP) and in some cases a formalized contractual document.

A “peer” relationship exists between networks when two networks exchange traffic between their users freely and for mutual benefit. Thus, peers do not charge one another for exchanging traffic and this relationship is referred to as a “settlement free peer” relationship. Generally, the motivation behind peering is to reduce costs for transit services. Additional motivations for peering include increasing redundancy, capacity, routing control and improved performance.

In the illustrative embodiment shown in FIG. 1A, the CSP 100 is communicatively coupled to four illustrative peers send and receive data at several Gigabit per second (Gbps) rate, which may also be represented as (Gb) and (G). The Gigabit values are associated with an arrow, wherein the arrow's direction indicates which direction the volume of data is traveling.

In the illustrative embodiment, a first Peer 110 is communicatively coupled to CSP 100 and, by way of example, sends 30 Gb of data to the CSP 100 and receives 30 Gb of data from CSP 100. Similarly, a second Peer 120 is also communicatively coupled to CSP 100 and, also, sends 30 Gb of data and receives 30 Gb of data.

A third Peer 130 operates differently from first Peer 110 and second Peer 120. The third Peer 130 sends 50 Gb of data to the CSP 100 and receives 10 Gb of data from the CSP 100. A fourth Peer 140 also operates differently from the other Peers 110, 120 and 130. The fourth Peer 140 sends 10 Gb of data to the CSP 100 and receives 50 Gb of data from the CSP 100.

Referring to FIG. 1B, there is shown an illustrative Table I that includes Input Output (I/O) ratios and Total Cost per Mile. The I/O ratio is relied upon by peering managers to determine the fairness of a peer relationship. The I/O ratio may be used to determine the maximum allowable asymmetry in traffic exchange to be considered a “peer.”

Peering managers look to bit-miles to determine the fairness of a relationship. A bit-mile is a value determined from the amount of traffic (e.g., the number of gigabits) and the geographical distance the data must traverse through network paths to reach its destination. This calculation may take all route segments and calculate the average cost per mile, resulting in a $/bit-mile cost number. Bit-mile information may also be used in a gross traffic analysis, which determines the relative amount of network bit-mile resources a customer actually uses.

Between the first Peer 110 and the second Peer 120, peering managers generally think that either peer is equally desirable as the I/O ratio is 1. However, if bit-miles are taken to be a proxy for network cost, it is clear that the second Peer 120 is driving much larger cost and hence should be less desirable than the first Peer 110. The third Peer 130 would be termed as unfair since it is driving much more traffic to the CSP 100 network than the CSP is sending to the Peer. The fourth Peer 140 would be presumed to be equally undesirable, as seen from the cost perspective, both the third Peer 130 and the fourth Peer 140 drive equal network. The above analysis leads to a conclusion that currently available methods are unsatisfactory to evaluate the business value of peers.

As stated previously, peering is a voluntary interconnection of administratively separate Internet network for the purpose of exchanging traffic between the users of each network. The motivation behind peering is to reduce costs for transit services, increasing redundancy, capacity, routing control and improved performance.

Additionally, a “customer” relationship, i.e. sell, may exist between the networks. In a “customer” relationship, a network sells Internet access to another network. Note, the term “customer” is also used to describe a “transit” relationship, in which the network operator pays money, i.e. buys, Internet access from another network. Thus, the “customer” relationship refers to either the sell or buy side of the customer relationship.

The systems and methods presented herein rely on “peer margins” or “profitability” being determined by the combination of network costs due to traffic carried and attributed revenues generated from the traffic. Once costs and revenues are known for each peer, then the process of computing margins and business value for each peering relationship is straightforward. The systems and methods presented herein rely on determining peer margins according to the following equation:

Peer Margin (Profitability)=Attributed Revenues−Network Cost

Total network costs for each peer can be determined using a variety of different cost metrics such as average bit-mile cost*bit-miles or any other method for attributing one or more network asset costs to peer traffic. For example, another cost metric is described in commonly assigned patent application entitled System and Method for Network Cost Attribution.

Attributed revenue is based on customer revenues that are earned at customer ports. More specifically, customer revenues are attributed to the appropriate peer in the system and method presented herein. The process of attributing customer revenues to the appropriate peer may be fairly complex because peer traffic flows are analyzed and are associated with customer revenue generation.

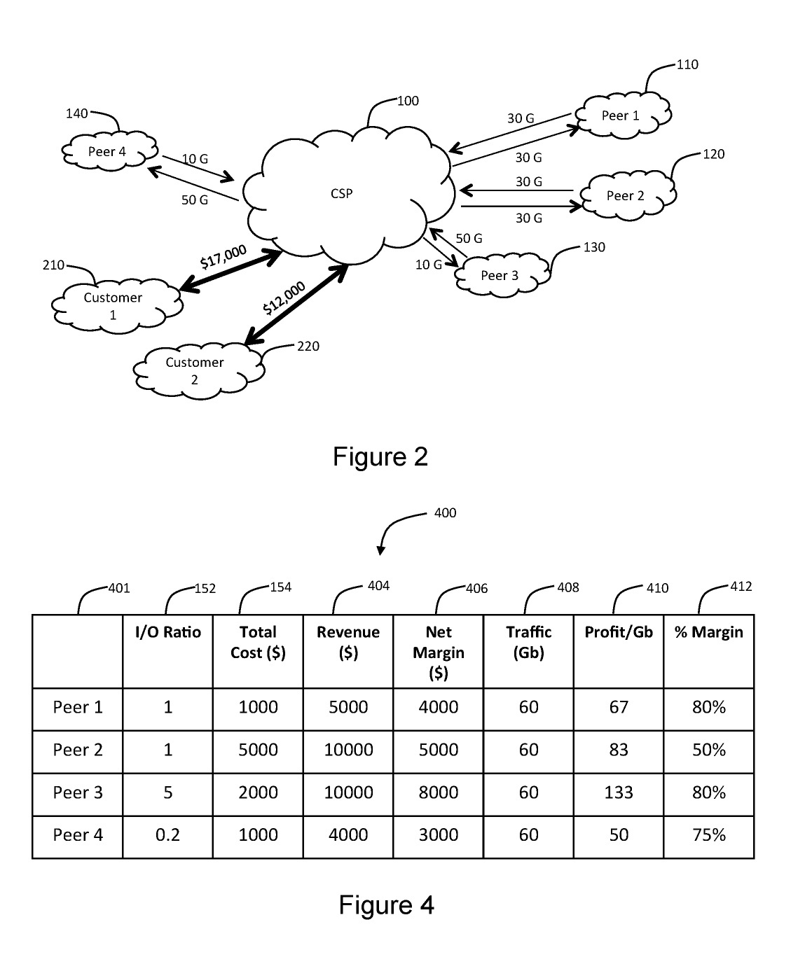

Referring to FIG. 2 there is shown two customers communicatively coupled to CSP 100, which is in communication with the network peers presented in FIG. 1A. The first Customer 210 and second Customer 220 are shown as end-users of the traffic exchanged by the Peers 110, 120, 130 and 140.

In the illustrative embodiment, the Customers 210 and 220 pay the CSP 100 based on a 95^{th} percentile traffic level for higher of the in/out traffic. A 95th percentile billing method allows a customer to have a short (less than 36 hours, given a monthly billing period) burst in traffic without overage charges. For example, 95% of the time a given peer's usage is at or below the amount billed for. Conversely, 5% of the data usage samples may be bursting above the rate billed for. This billing method is an alternative to either capped ports with fixed billing or actual data transferred, which are models more frequently utilized outside a datacenter setting, where occasional bursting is either not allowed or penalized with higher bills.

Traffic reporting tools such as Netflow can be used to compute traffic matrices from Customer to Peers. A traffic reporting tool is any system that monitors network traffic as it enters and/or exits an interface. Traffic reporting tools provide network traffic information, which CSPs may then use to evaluate traffic flows between the CSP and associated peer networks. One such traffic reporting tool is Cisco IOS Netflow.

Netflow is a system providing the ability to collect IP network traffic information as it enters or exits a given interface. Netflow allows a network administrator to determine the source and destination of traffic, and a class of service associated with the traffic. Netflow performs by associating any unidirectional sequence of data packets that all share seven values: ingress interface, source IP address, destination IP address, IP protocol, source port for UDP or TCP (all other protocols receive a 0 value), destination port for UDP or TCP and type and code for IMCP (all other protocols receive a 0 value), and IP type of service. Netflow has three components: a flow exporter, a flow collector, and an analysis application. The flow exporter aggregates packets into flows, and exports flow records towards one or more flow collectors. Flow collectors are responsible for reception, storage, and pre-processing of flow data received from a flow exporter. An analysis application analyzes received flow data in the context of various parameters such as intrusion detection or traffic profiling.

FIG. 2 also shows a peer traffic interaction for each customer, in which revenue is being generated from interactions that are attributed to one or more peers. For example, if the first Customer 210 only interacts with the third Peer 130 and pays $17,000 for the receive traffic, then the third Peer 130 would be attributed $17,000. The first Customer 210 communicating with third Peer 130 assumes that first Customer 210 is charged for “sent traffic” and that no other Peer is attributed any revenue for the first Customer 210 data traffic.

With respect to the second customer 220, the second customer 220 is charged $12,000 for communicating with the CSP 100. In the illustrative embodiment, the second Customer 220 is charged for “received traffic,” in which 25% of this traffic originated from first Peer 110 and 75% of the traffic originated from second Peer 120. In view of having 25% of the traffic originated from first Peer 110, then first Peer 110 is attributed revenue of $3,000. Since 75% of the traffic originated from the second Peer 120, then second Peer 120 would be attributed revenue of $9,000 from the total of $12,000 charged to second Customer 220.

The illustrative embodiments presented in FIG. 2 provide an illustrative example of the process for attributing revenue to one or more Peers based on the CSP charging the Customer for interacting with the CSP 100. More generally, attributed revenue relates to the process of segregating the total revenue based on the contribution made by each Peer to communicating the sent traffic or received traffic. In other words, attributed revenue of a peer is the actual customer revenue earned by CSP 100 for the traffic exchanged with that peer.

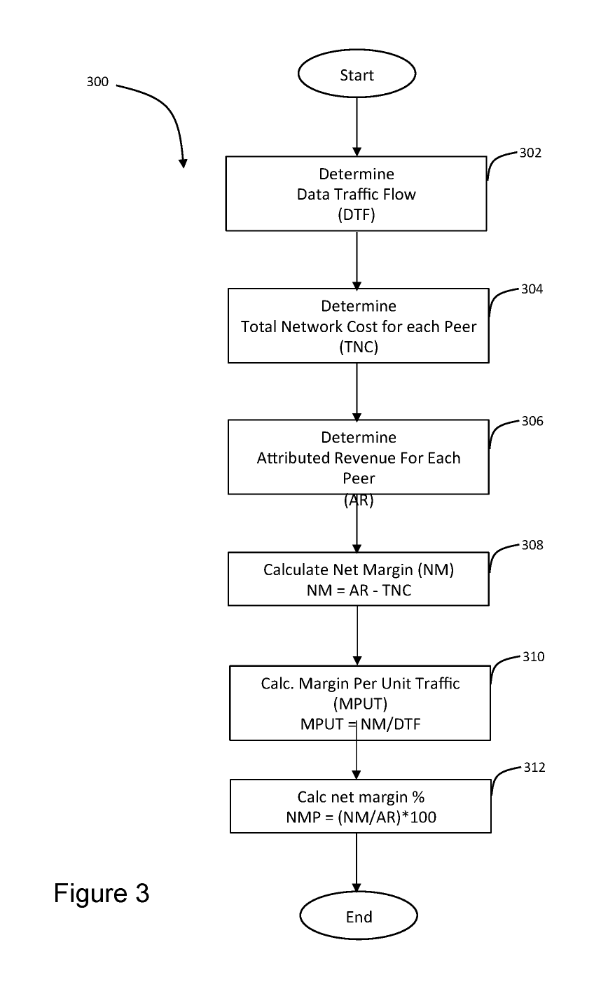

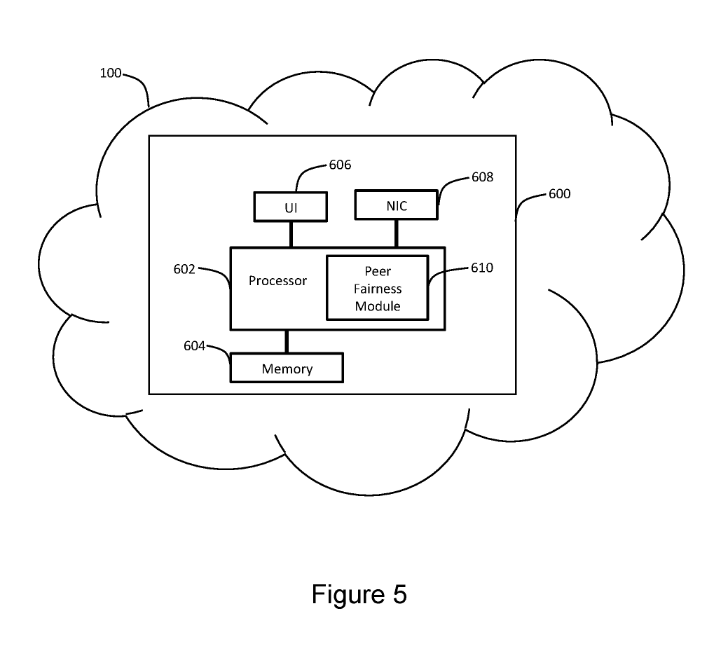

Referring to FIG. 3, there is shown an illustrative flowchart for determining attributed revenue, which is used for ranking peers and determining the business value of the peering relationship. The illustrative method 300 incorporates revenues to determine the business value of peering. Additionally, the method 300 can use values generated by the CSP 100 and which are processed by a CSP sub-system 600, which is described in further detail below with reference to FIG. 5. Furthermore, the illustrative method 300 may be implemented without complex statistics or probabilistic models.

The fairness of the peering relationship method 300 is initiated at block 302 where a determination of data traffic flow (DTF) is performed. By way of example and not of limitation, the traffic data flow may be based on bandwidth such as gigabits per second (Gbps). The traffic data flow may also be presented as a total of sent data traffic flow and received data traffic flow. The sent data traffic flow and received data traffic flow may also be described as an In/Out (I/O) traffic ratio, where the “In” traffic is the “sent” data traffic flow from a Peer and the “Out” traffic corresponds to a peer's “received” data traffic flow. Thus, a “sent/received” data traffic flow corresponds to an “I/O” traffic ratio.

The method then proceeds to block 304 where a total network cost (TNC) value for each peer is determined or calculated. As described above, an illustrative metric for determining the total network cost may include bit-miles, which is a value determined from the amount of traffic (e.g., the number of gigabits) and the geographical distance the data must traverse through network paths to reach its destination. As stated above, this calculation may take all route segments and calculate the average cost per mile, resulting in a $/bit-mile cost number.

At block 306, the method then proceeds to determine the attributed revenue for each peer. As described above, attributed revenue relates to the process of segregating the total revenue based on the contribution made by each Peer communicating the sent traffic or the received traffic.

For example, attributed revenue for peers may be based on customers being billed on 95^{th} percentile traffic level during an entire month. In another illustrative example, the higher of sent bit-rate or received bit-rate may be used to attribute revenue to each appropriate peer. Additionally, other monitored billing or revenue parameter such as fixed price billing or tiered billing may be used for revenue attribution to one or more peers.

Attributed revenue may be performed according to monthly traffic matrices. For example, attributed revenue may be determined based on “average” level of traffic flows in a month from a given customer to peer interaction. Other methods such as allocation based on P95 traffic levels may not work well because of the inconsistency of P95 timings between a customer and the peer interactions.

Attributed revenues may also be based on monthly revenues, which corresponds to traffic data flow attributed to peers that generate revenue based on the direction of the traffic flow data. For example, if the customer sends 2 Gbps of traffic and receives 10 Gbps of traffic, then the illustrative customer may only be billed for the received 10 Gbps of data traffic. In this illustrative embodiment, the Peers that contributed to the 10 Gbps will be attributed revenues and the 2 Gbps of traffic is ignored for any revenue attribution computations.

The method then proceeds to block 308 where the net margin (NM) is calculated by finding the difference between the attributed revenue (AR) from block 306 and the total network cost (TNC) from block 304. The CSP 100 may calculate the NM, AR and TNC from internal numbers, which can be easily implemented at the CSP 100. Net margin is the first parameter of determining a peer's business relationship value.

The method then proceeds to block 310 where the margin per unit traffic (MPUT) is calculated by taking the net margin (NM) and dividing by the data traffic flow (DTF). The resulting margin per unit traffic (MPUT) is the second parameter of determining a peer's business relationship value.

The method then proceeds to block 312 where net margin percentage is calculated by taking the net margin (NM), dividing by the attributed revenue (AR), and multiplying the result with 100. The resulting net margin percentage (NMP) is the third parameter of determining a peer's business relationship value.

Net margin (NM), margin per unit traffic (MPUT), and net margin percentage (NMP) together provide a comprehensive view of a peer's business relationship value (PBRV) for the CSP. For example, a peer with higher NMP but same MPUT is more desirable. Likewise, a peer with very high NM is very desirable even if it does not have most favorable MPUT or NMP.

The steps performed from blocks 302 through 310 each rely on normalizing the performance of the network around each peer. In statistics, normalization refers to generating values for datasets in a way that eliminates the effects of gross influences. In the method steps described above, there is substantial reliance on developing a peer business relationship value (PBRV) for each peer. Fundamentally, the peer business relationship value ratio shares a price component, which are normalized based on data traffic flow (DTF).

Referring to FIG. 4 there is shown a table that illustrates developing peer business relationship value view. In the illustrative example shown in FIG. 4, the relationship with the third Peer 130 is highly desirable relationship because it generates the highest NM, MPUT, and NMP even though it has an “unfair” I/O ratio.

In FIG. 4 there is shown a peer relationship table that includes the I/O Ratio 152 that was presented in FIG. 1. The peer relationship table 400 includes a Peer column 401 on the far left that identifies the peers that make up the peer relationship table. The peers are composed of first Peer 110, which is identified as “Peer 1” in table 400. Additionally, the second Peer 120 is labelled as “Peer 2,” the third Peer 130 is labelled as “Peer 3,” and the fourth Peer 140 is labelled as “Peer 4.”

Adjacent to the Peer column 401 is the Input Output (I/O) ratio column 152, where “Input” or “In” traffic is the sent data traffic flow from the Peer and the “Output” or “Out” traffic corresponds to a peer's received data traffic flow. Table 4 shows that the I/O ratio for first Peer 110 and second Peer 120 are both “1.” The I/O ratio for the third Peer 130 is “5” and the I/O ratio for the fourth Peer 140 is “0.2.”

Column 154 presents the total network cost (TNC) for a given peer relationship between the CSP 100 and a particular Peer, which is similar to FIG. 1B. By way of example and not of limitation, the TNC for a peer relationship is measured with a bit-mile value, which is a value determined from the amount of traffic (e.g., the number of gigabits) and the geographical distance the data must traverse through network paths to reach its destination. Table 4 shows that the TNC for first Peer 110 and fourth Peer 140 are both $1,000/bit-mile. With respect to the second Peer 120, the TNC is $5,000/bit-mile and for third Peer 130, the TNC is $2,000/bit-mile.

Column 404 represent the attributed revenue (AR) for each Peer. The attributed revenue relates to the process of segregating the total revenue based on the contribution made by each Peer communicating the sent traffic or the received traffic.

At column 406, the Net Margin (NM), which is also referred to as “net profit,” is calculated by subtracting the total network cost (TNC) in column 402 from the attributed revenue (AR) in column 404.

Column 408 is related to the data traffic flow (DTF). By way of example and not of limitation, the data traffic flow is presented as Gigabits per second (Gbps) or (Gb). In the illustrative embodiment, each peer 110, 120, 130 and 140 have the same data traffic flow of 60 Gbps. In column 408, the illustrative DTF value is calculated by summing the sent and received data traffic flow. In another illustrative embodiment (not shown), sent data traffic values may be used to represent data traffic flow. In yet another illustrative embodiment (not shown), received data traffic values may be used to represent data traffic flow. In yet another illustrative embodiment (not shown), higher of sent or received P95 data traffic values may be used to represent data traffic flow.

At column 410, the peer margin per unit traffic is calculated by dividing the net margin (NM) with the data traffic flow (DTF). Column 410 shows the highest margin per unit traffic is associated with the third peer 130 because it generates the highest net margin even though it has an “unfair” or highest I/O ratio.

At column 412, the peer net margin percentage is calculated by taking the net margin (NM), dividing by the attributed revenue (AR), and multiplying the result with 100.

Table 400 also shows that even though first peer 110 and fourth peer 140 have a lower total cost of $1,000/bit-mile, the peer business relationship value for the third peer 130 is greater because of the highest NM, MPUT, and NMP associated with the third peer 130. Thus, Table 400 shows that desirability of peers cannot be ascertained based on costs and/or I/O ratio only. More importantly, attributed revenue numbers must be used for ranking the peers and determining PBRV.

Referring to FIG. 5, there is shown an illustrative sub-system associated with the communications service provider (CSP) 100. In the illustrative embodiments presented above, the sub-system 600 is communicatively coupled to one or more network peers and operates behind the CSP 100 firewall. The sub-system 600 calculates the peer fairness by retrieving or determining a total network costs, attributed revenue and data traffic flow.

More specifically, the sub-system 600 includes at least one processor 602 that is communicatively coupled to a memory 604. Multiple processors may also perform the operations described. Additionally, the illustrative CSP sub-system communicates with a user interface (UI) 606 that receives inputs that are processed by illustrative processor 602. The CSP sub-system 600 may also be networked to other sub-systems with an illustrative network interface card (NIC) 608 or other communications pathways, e.g. a serial bus. A peer business relationship value module 610 is an illustrative software module that is configured to perform the peer business relationship value calculations described above.

The CSP sub-system 600 may operate in centralized system architecture, distributed system architecture or any combination thereof. Additionally, the operations performed by the CSP sub-system 600 may be performed by any network asset that is securely accessible by the CSP 100.

The systems and methods presented herein incorporate revenues to determine the business value of peering and not just cost and traffic level. Additionally, the systems and method presented herein are based on operating within the CSP sub-system, which receives internal CSP numbers that do not require estimating the benefits to peers. Furthermore, the systems and methods described above may be implemented easily without complex statistics or probabilistic methods. Further yet, the systems and methods presented herein may be used to evaluate benefits for all existing peering relationships.

It is to be understood that the detailed description of illustrative embodiments is provided for illustrative purposes. The scope of the claims is not limited to these specific embodiments or examples. Therefore, various process limitations, elements, details, and uses can differ from those just described, or be expanded on or implemented using technologies not yet commercially viable, and yet still be within the inventive concepts of the present disclosure. The scope of the invention is determined by the following claims and their legal equivalents.

What is claimed is:

1. A method for determining a peer business relationship value, the method comprising:
enabling at least one settlement free peers to communicate with a communications service provider (CSP), wherein the CSP includes a CSP sub-system that receives a plurality of peer information;
receiving, at the (CSP) sub-system, a total network cost for each peer, wherein the total network cost includes a network asset cost;
determining, at the CSP sub-system, a data traffic flow for each peer, wherein the data flow traffic includes a network bandwidth;
determining, at the CSP sub-system, an attributed revenue for each peer, wherein the attributed revenue is attributed to one or more peers;
calculating, at the CSP sub-system, a net margin that is calculated by subtracting the total network cost from the attributed revenue;
calculating, at the CSP sub-system, the peer margin per unit traffic by taking the net margin and dividing by the data traffic flow;
calculating, at the CSP sub-system, the peer net margin percentage by taking the net margin, dividing it by the attributed revenue, and multiplying the result with 100; and
using net margin, margin per unit traffic, and net margin percentage together to determine the business relationship value of each CSP peer

2. The method of claim 1 further comprising updating the peer business relationship value at a regular interval due to changes in at least one of the data traffic flow, the attributed revenue and the total network cost.

3. The method of claim 2 wherein the attributed revenue is determined monthly.

4. The method of claim 2 further comprising ranking each peer at the regular intervals according to their peer relationship value to identify the highest value peer.

5. The method of claim 1 wherein the attributed revenue is calculated based on a 95^{th} percentile traffic level.

6. The method of claim 1 wherein the attributed revenue is calculated based on a direction of the data traffic flow.

7. The method of claim 1 wherein the total network cost is calculated based on a cost metric.

8. A method for determining a peer business relationship value, the method comprising:
enabling at least one settlement free peer to communicate with a communications service provider (CSP), wherein the CSP includes a CSP sub-system that receives a plurality of peer information;
determining, at the CSP sub-system, a data traffic flow for each peer, wherein the data flow traffic includes a network bandwidth;
receiving, at the (CSP) sub-system, a total network cost for each peer, wherein the total network cost includes a network asset cost;
determining, at the CSP sub-system, an attributed revenue for each peer, wherein the attributed revenue is attributed to one or more peers;
calculating, at the CSP sub-system, a net margin that is calculated by subtracting the total network cost from the attributed revenue;
calculating, at the CSP sub-system, the margin per unit traffic by taking the net margin and dividing by the data traffic flow;
calculating, at the CSP sub-system, the net margin percentage by taking the net margin, dividing it by the attributed revenue, and multiplying the result with 100;
using net margin, margin per unit traffic, and net margin percentage to develop a comprehensive view of business relationship value of each peer; and
updating the peer relationship's business value at a regular interval, at the CSP sub-system, due to changes in at least one of the data traffic flow, the attributed revenue and the total network cost.

9. The method of claim 8 wherein the total network cost is calculated based on a cost metric.

10. The method of claim 9 wherein the attributed revenue is determined monthly.

11. The method of claim 10 wherein the attributed revenue is calculated based on a 95^{th} percentile traffic level.

12. The method of claim 10 wherein the attributed revenue is calculated based on a direction of the data traffic flow.

13. The method of claim 11 further comprising ranking each peer at the regular intervals according to their peer relationship value to identify the highest value peer.

14. A system for determining a peer business relationship value, the system comprising:
a communications service provider (CSP) communicatively coupled to at least one peer, wherein the CSP include a CSP sub-system that receives a plurality of peer information;
the CSP sub-system determining a data traffic flow for each peer, wherein the data flow traffic includes a network bandwidth;
the CSP sub-system receiving a total network cost for each peer, wherein the total network cost includes a network asset cost;
the CSP sub-system determining an attributed revenue for each peer, wherein the attributed revenue is attributed to one or more peers and a total of the attributed revenue equals the customer revenue earned from traffic exchanged with peers;
the CSP sub-system calculating a net margin that is calculated by subtracting the total network cost from the attributed revenue;
the CSP sub-system calculating the peer business relationship value by taking the net margin and dividing by the data traffic flow; and
the CSP sub-system updating the peer business relationship value at a regular interval due to changes in at least one of the data traffic flow, the attributed revenue and the total network cost.

15. The system of claim 14 wherein the total network cost is calculated based on a cost metric.

16. The system of claim 14 wherein the attributed revenue is determined monthly.

17. The system of claim 14 wherein the attributed revenue is calculated based on a 95^{th} percentile traffic level.

18. The system of claim 14 wherein the attributed revenue is calculated based on a direction of the data traffic flow.

19. The system of claim 14 further comprising ranking each peer at the regular intervals according to their peer relationship value to identify the highest value peer.

20. The system of claim 14 wherein the peers exchanging information do not charge one another.
